(19) United States
(12) Patent Application Publication
(10) Pub. No.: US 2012/0121905 A1
(43) Pub. Date: May 17, 2012

(54) PROCESS FOR PRODUCING EXPANDABLE THERMOPLASTIC BEADS WITH IMPROVED EXPANDABILITY

(75) Inventors: Holger Ruckdäschel, St. Martin (DE); Carsten Schips, Speyer (DE); Klaus Hahn, Kirchheim (DE); Jens Aßmann, Mannheim (DE); Maximilian Hofmann, Mannheim (DE)

(73) Assignee: BASF SE, Ludwigshafen (DE)

(21) Appl. No.: 13/291,357

(22) Filed: Nov. 8, 2011

Related U.S. Application Data
(60) Provisional application No. 61/412,440, filed on Nov. 11, 2010.

(51) Int. Cl. B32B 27/00; C08J 9/18

(52) U.S. Cl. 428/402; 521/80

(57) ABSTRACT

A process for producing expandable, thermoplastic polymer beads comprising cavities via extrusion of a polymer melt comprising blowing agent through a die plate and pelletization in a chamber comprising liquid under a pressure in the range from 1.5 to 15 bar, which comprises using a polymer melt comprising blowing agent, where the melt comprises
from 0.1 to 5% by weight of a nucleating agent D),
from 1 to 10% by weight of a blowing agent E) which in essence remains within the polymer beads,
from 0.01 to 5% by weight of a co-blowing agent F) forming the cavities,
   based in each case on the polymer melt comprising blowing agent, and also the expandable thermoplastic polymer bead material which can be obtained by the process, comprising cavities with an average diameter in the range from 0.1 to 50 μm.

### CROSS-REFERENCE TO RELATED APPLICATIONS

This application claims benefit (under 35 USC 119(e)) of U.S. Provisional Application 61/412,440, filed Nov. 11, 2010 which is incorporated by reference.

### BACKGROUND OF THE INVENTION

The invention relates to a process for producing expandable thermoplastic polymer beads comprising cavities via extrusion of a polymer melt comprising blowing agent through a die plate and pelletization in a chamber comprising liquid under a pressure in the range from 1.5 to 15 bar.

Expandable moldable foams can be produced by the suspension process, via postimpregnation of polymer pellets or by the melt extrusion process. The melt extrusion process is particularly versatile in respect of possible starting materials and additives.

Methods for producing expandable polymers by the melt impregnation process are known. Application to various polymer systems has now been demonstrated for a number of materials, for example for acrylonitrile-containing styrene copolymers (WO 2009/000872) and for elastified expandable moldable foams (WO 2009/112549).

The properties of moldable foams are markedly dependent on the cell structure, e.g. cell size or cell size distribution. By way of example, therefore, thermal, mechanical and optical properties, and feel, can be altered by influencing the cell size. Because of the process-technology parameters that apply, only limited control of the cell structure can be achieved without changing the constitution of the material.

Control of the cell size is therefore often achieved by using nucleating agents, examples being inorganic additives, and organic nucleating agents such as waxes, where these provide an interlace to the system and thus reduce the energy barrier for heterogeneous nucleation at the phase boundary between polymer and nucleating agent.

However, nucleating agents of this type have only limited suitability, because they sometimes have low efficiency and they have an adverse effect on the mechanical properties or fire properties of the foam. By way of example, addition of inorganic, particulate nucleating agents such as talc can reduce toughness, characterized for example via bending energy or resistance to cracking. Although it is possible to use compatibilizers or surface-modified fillers to improve the coupling of the inorganic nucleating agents thus to improve mechanical properties, these in turn exhibit lower nucleating efficiency.

The inorganic nucleating agents should moreover have low solubility in the polymer requiring nucleation, so as to allow phase separation. By way of example, therefore, olefinic waxes cannot be used in olefinic polymers. Organic nucleating agents, such as olefinic waxes, e.g. Luwax®, are not suitable for all materials. Again, toughened styrene foams cannot use olefinic nucleating agents, since they do not provide phase separation within the material but instead migrate into the polyolefin phases. It is then impossible to achieve effective nucleation. An increase in cell density can likewise be achieved via use of low-solubility blowing agents. However, blowing agents of this type require very high solution pressures and exhibit a long residence time in the prefoamed beads or fully foamed moldings, i.e. they have disadvantages specific to the process and to the application.

The use of organic blowing agents and of inert gases for control of the foam structure and foam properties of expandable polymers has not hitherto been widely described. Some relevant patent specifications are collated below, and encompass not only foam extrusion but also expandable and expanded beads.

WO 2004/022636 describes the production of foam beads using water as blowing agent. In order to improve water-compatibility, solubilizers such as ethanol and acetone are used. Further blowing agents are moreover used, for example pentane, butane, and/or CO₂. A primary aim of water addition is to reduce the amounts of the organic blowing agents in the expandable pellets, and no effect on cell size is described.

DE 198 190 58 describes the production and use of expandable styrene polymers with a low level of incipient foaming. Incipient foaming to bulk densities which are below the bulk density of the unfoamed materials by from 0.1 to 20% can be achieved by variation of the process parameters in the suspension polymerization process and in the melt impregnation process, using pentane as blowing agent. The intention of the incipient foaming is to permit production of foams with relatively coarse cells. However, achievement of homogeneous incipient foaming of the material is very highly dependent on the process conditions selected and there is restricted scope for variation.

WO 2005/092959 describes the use of a plurality of blowing agents in multiphase polymer systems. An aim here is to produce nanoporous foams via selective impregnation of a nanoscale structure with a blowing agent and subsequent foaming. A necessary precondition for achieving the fine-cell structure here is a multiphase blend structure.

By way of example, EP-A 846 141 describes the use of blowing agent combinations. The continuous conduct of a process for producing expandable styrene polymers adds C₃-C₇ hydrocarbons individually or in a mixture with CO₂ as blowing agent. The process comprises bulk polymerization of the styrene polymer as far as a certain conversion, the dispersion of the resulting prepolymer in liquid form in an aqueous phase with suspension stabilizer, and subsequent polymerization to completion. Blowing agents can be added during any of the steps of the process. When CO₂ is used it is moreover advantageous to use CO₂ absorbers. There is no description of any specific function of the CO₂ during or after the production process.

EP-A 987 292 describes the preexpansion of vinylaromatic polymers to give a bulk density of from 200-600 g/l, and the subsequent postexpansion of the material after impregnation with inorganic gases, specifically with O₂— or N₂-containing gases. The preexpansion and postimpregnation steps here take place at different times. The postimpregnation step is required for expansion in all cases.

EP-B 1 000 115 describes a process for producing expandable polymer pellets specifically based on polystyrene. After impregnation of the polymers with suitable blowing agents, an atomization process, and subsequent cooling of the resultant pellets, takes place. Possible blowing agents mentioned are inter alia hydrocarbons, chlorofluorocarbons, CO₂, N₂, and air, or noble gases. No particular effects are described for use of CO₂, N₂, and air.

U.S. Pat. No. 2,864,778 describes the use of small proportions of CO₂ in addition to aliphatic hydrocarbons to produce expandable styrene polymers. Addition of CO₂ prior to or during the polymerization reaction by the suspension process can produce relatively fine-cell foams. The proportion needed for this purpose is described as very small. In the examples, effects occur even at proportions of 0.4% by weight and less. There is no description of other systems for achieving fine-cell products, or of other processes for producing expandable styrene polymers.

U.S. Pat. No. 3,328,497 describes the use of gases, specifically of N₂ and air, for producing foams from expandable styrene polymers and interpolymers. The process described comprises the partial expansion of the expandable polymer, which includes an organic blowing agent with a boiling point below 80° C., and rapid transfer into an atmosphere with increased gas pressure and low temperature. In a final step, the foam is obtained via further expansion in a closed mold at increased temperatures. The absorption of the gases described by the pellets is achieved by analogy with EP 987 292 after the preexpansion of the materials, and no particular effects on cell structure are described.

U.S. Pat. No. 5,391,581 describes the use of blowing agent mixtures made of aliphatic hydrocarbons or of alicyclic hydrocarbons and CO₂ for producing foam beads made of ethylene-based resins. The cell size of the expanded pellets can be made homogeneous by using CO₂ and additionally introduced, inorganic nucleating agents, but, unlike with expandable beads, no additional expansion prior to production of moldings is possible.

US 2006/0022366 describes the extrusion of foam sheets (XPS) of styrene-based polymer systems with use of a plurality of blowing agents. Materials used as blowing agents in combination with isobutane, n-pentane, isopentane, or a mixture thereof are advantageously water, CO₂, ethers, or dialkyl carbonates with a boiling point below 140° C. The use of the blowing agents mentioned and of the permeation process which is more rapid when comparison is made with air generates a reduced pressure after the foaming process, and this is advantageous for further shaping processes.

US 2007/0049649 describes a process for producing foamed polymer beads comprising microcavities, where the polymer is processed with a gas under high pressure or a liquid in the supercritical state in an extruder to give a homogeneous single-phase mixture, and is extruded.

EP-A 0 761 729 describes expandable styrene resin beads with fewer than 100 microcavities of diameter about 0.1 to 30 μm, which are obtained via suspension polymerization in the presence of a persulfate and of an electrolyte.

### A SUMMARY OF THE INVENTION

It was an object of the present invention to discover a process for producing expandable thermoplastic polymer beads with improved expandability which while having reduced blowing agent contents blowing agent, where the melt comprises nevertheless permit faster prefoaming and controlled adjustment of cell structure.

Accordingly, a process has been discovered for producing expandable, thermoplastic polymer beads comprising cavities via extrusion of a polymer melt comprising blowing agent through a die plate and pelletization in a chamber comprising liquid under a pressure in the range from 1.5 to 15 bar, which comprises using a polymer melt comprising blowing agent, where the melt comprises
from 0.1 to 5% by weight, preferably from 0.3 to 1.0% by weight, of a nucleating agent D),
from 1 to 10% by weight, preferably from 2 to 6% by weight, of a blowing agent E) which in essence remains within the polymer beads,
from 0.01 to 5% by weight, preferably from 0.05 to 1% by weight, of a co-blowing agent F) forming the cavities,

based in each case on the polymer melt comprising blowing agent.

### A BRIEF DESCRIPTION OF THE FIGURES

FIGS. 1 and 2 show transmission electron micrographs at various magnifications of a thin section through an expandable pellet from Example 13 with homogeneously distributed cavities in the interior of the pellet bead.

### A DETAILED DESCRIPTION OF THE INVENTION

Surprisingly, it has been discovered that the use of volatile, liquid/gaseous co-blowing agents F) which form cavities can achieve a cellular structure in the expandable pellets, with the result that the subsequent foaming procedure can be improved and the cell size can be controlled.

Suitable nucleating agents D) are inorganic or organic nucleating agents. Examples of suitable inorganic nucleating agents are talc, silicon dioxide, mica, clay, zeolites, or calcium carbonate.

Examples of suitable organic nucleating agents are waxes such as the polyethylene waxes marketed as Luwax®. It is preferable to use talc.

The blowing agent used (component E) comprises from 1 to 10 per cent by weight, preferably from 3 to 8 per cent by weight, based on the entirety of components A) to F) of the polymer melt comprising blowing agent, of a physical blowing agent. The blowing agents can be gaseous or liquid at room temperature (from 20 to 30° C.) and atmospheric pressure. Their boiling point should be below the softening point of the polymer mixture, usually in the range from −40 to 80° C., preferably in the range from -10 to 40° C. Examples of suitable blowing agents are halogenated or halogen-free blowing agents, e.g. aliphatic C₃ to C₈-hydrocarbons, alcohols, ketones, or ethers. Examples of suitable aliphatic blowing agents are aliphatic C₃ to C₈-hydrocarbons such as n-propane, n-butane, isobutane, n-pentane, isopentane, n-hexane, neopentane, cycloaliphatic hydrocarbons such as cyclobutane and cyclopentane, halogenated hydrocarbons such as methyl chloride, ethyl chloride, methylene chloride, trichlorofluoromethane, dichlorofluoromethane, dichlorodifluoromethane, chlorodifluoromethane, dichlorotetrafluoroethane, and mixtures thereof. Preference is given to the following halogen-free blowing agents: isobutane, n-butane, isopentane, n-pentane, neopentane, cyclopentane, and mixtures thereof.

Blowing-agent-retention capability after storage can be improved, and lower minimum bulk densities can be achieved, if the blowing agent preferably comprises a proportion of from 25 to 100 percent by weight, particularly preferably from 35 to 95 percent by weight, based on the blowing agent, of isopentane or cyclopentane. Particular preference is given to use of mixtures made of from 30 to 98% by weight, in particular from 35 to 95% by weight, of isopentane and from 70 to 2% by weight, in particular from 65 to 5% by weight, of n-pentane.

Blowing agents E) preferably used comprise aliphatic C₃-C₇-hydrocarbons or a mixture thereof, particularly preferably isobutane, isopentane, n-pentane and mixtures thereof. It is preferable that the polymer melt comprising blowing agent comprises less than 0.5% by weight of water.

The process for adjusting to said cavity morphology can also be termed prenucleation, and the cavities are in essence formed via the co-blowing agent F).

The co-blowing agent F) forming the cavities differs from the actual blowing agent E) in its solubility in the polymer. In the production process, blowing agent E) and co-blowing agent F) are initially dissolved completely in the polymer at sufficiently high pressure. The pressure is then reduced, preferably within a short period, and the solubility of the co-blowing agent F) is thus reduced. This causes onset of phase separation within the polymeric matrix, and a prenucleated structure is produced. Because the actual blowing agent E) has relatively high solubility and/or has low diffusion rate, it remains predominantly dissolved in the polymer. A temperature reduction is preferably carried out simultaneously with the pressure reduction, in order to inhibit excessive nucleation of the system and to reduce diffusion of the actual blowing agent E) out the material. This is achieved by using co-blowing agent F) in conjunction with ideal pelletization conditions.

It is preferable that at least 80% by weight of the co-blowing agent F) escapes within the period of 24 h from the expandable thermoplastic beads on storage at 25° C., atmospheric pressure, and 50% relative humidity. The solubility of the co-blowing agent F) in the expandable thermoplastic beads is preferably below 0.1% by weight.

It is preferable to use co-blowing agents F) which moreover have a higher diffusion rate and/or increased permeability and/or an increased vapor pressure when comparison is made with the actual blowing agent E); it is particularly preferable that the co-blowing agents F) exhibit a plurality of these characteristics. In order to provide additional support for the nucleation process, small amounts of conventional nucleating agents can be used, examples being inorganic particles, such as talc.

In all cases, the amount added of the co-blowing agent F) used during the prenucleation process should exceed the maximum solubility under the prevailing process conditions. It is therefore preferable to use co-blowing agents F) which have low, but adequate, solubility in the polymer. Among these are in particular gases, such as nitrogen, carbon dioxide, and air, or noble gases, and particular preference is given to nitrogen, the solubility of which in many polymers decreases at low temperatures and pressures. However, it is also possible to use other, liquid additives.

It is particularly preferable to use inert gases, such as nitrogen and carbon dioxide. Features of both gases, alongside their suitable physical properties, are low cost, good availability, easy handling, and unreactive or inert behavior. By way of example, in almost all cases no degradation of the polymer occurs in the presence of the two gases. Since the gases are themselves obtained from the atmosphere, they also have no effect on the environment.

The amount of the co-blowing agent F) used here should: (i) be sufficiently small to dissolve at the given melt temperatures and given melt pressures during melt impregnation as far as pelletization; (ii) be sufficiently high to provide demixing from the polymer and nucleation at the water pressure and temperature used for pelletization. In one preferred embodiment, at least one of the blowing agents used is gaseous at room temperature and atmospheric pressure.

It is moreover preferable to use a co-blowing agent F) which, after prenucleation, escapes completely from the expandable pellets within a short time and therefore does not influence the further foaming process. It is particularly preferable to use nitrogen, carbon dioxide, argon, helium, or a mixture thereof as co-blowing agent F).

It is particularly preferable to use talc as nucleating agent D) in combination with nitrogen as co-blowing agent F).

Metal drums and octabins, inter alia, can be used for the transport and storage of the expandable pellets. If drums are used, a fact that has to be considered is that the liberation of the co-blowing agent F) can sometimes increase pressure within the drum. Packaging to be used is therefore preferably open packs, such as octabins or drums, where these permit dissipation of pressure via permeation of the gas out of the drum. Particular preference is given here to drums which permit escape of the co-blowing agent F) by diffusion and minimize or inhibit escape of the actual blowing agent E) by diffusion. This can be possible by way of example via selection of the sealing material in a manner appropriate to the blowing agent and, respectively, co-blowing agent F). It is preferable that the permeability of the sealing material to the co-blowing agent F) is higher by a factor of at least 20 than the permeability of the sealing material to the co-blowing agent E).

The prenucleation, for example via addition of small amounts of nitrogen and carbon dioxide, can establish a cellular morphology within the expandable pellets comprising blowing agent. The average cell size in the center of the beads can be greater here than in the peripheral regions, and the density can be higher in the peripheral regions of the beads. Losses of blowing agent are thus minimized as far as possible.

The prenucleation can achieve markedly better cell size distribution and a reduction of cell size after prefoaming. The amount of blowing agent needed to achieve a minimal bulk density is moreover smaller, and the storage stability of the material is moreover better. Small amounts of nitrogen or carbon dioxide added to the melt can lead to a marked reduction of the prefoaming times at constant blowing agent content or to a marked reduction of amounts of blowing agent at constant foaming times and at minimal foam densities. The prenucleation moreover improves product homogeneity and process stability.

Reimpregnation of the polymer pellets of the invention with blowing agents is moreover possible markedly more rapidly than with pellets of identical constitution and more compact, i.e. non-cellular, structure. Firstly, the diffusion times are smaller, and secondly, by analogy with direct-impregnated systems, smaller amounts of blowing agent are needed for foaming.

Finally, the prenucleation can reduce blowing agent content required to achieve a certain density, and can thus reduce the demolding times in the production of moldings or of slabs. This can reduce further-processing costs and improve product quality.

The prenucleation process can generally be used on all expandable beads. It is preferably used on materials with stringent requirements placed upon mechanical properties, and on systems where nucleating agents usually used have only slight effect. By way of example, in the case of elastified foams it is possible to achieve a marked improvement in fine-cell structure via addition of nitrogen or carbon dioxide.

The prenucleation principle can be utilized not only for suspension technology but also for melt impregnation technology to produce expandable beads. Preference is given to the use in the melt extrusion process, in which the addition of the co-blowing agents F) is pelletized via pressure-assisted underwater pelletization after discharge of the melt which has absorbed blowing agent. The microstructure of the pellets can be controlled as described above via selection of the pelletization parameters and of the co-blowing agent F).

Mixing to incorporate the blowing agent E) and co-blowing agent F) into the polymer melt can be achieved by way of dynamic mixers, such as extruders, or static mixers.

In the case of relatively high amounts of co-blowing agent F), for example in the range from 1 to 10% by weight, based on the polymer melt comprising blowing agent, lowering of melt temperature is a possibility, or lowering of melt viscosity, with a resultant marked increase in throughput. It is therefore also possible to achieve incorporation of thermally labile additives under non-aggressive conditions into the polymer melt, examples being flame retardants. There is no resultant alteration of the constitution of the expandable thermoplastic beads, since the co-blowing agent in essence escapes during the melt extrusion process. In order to utilize said effect, it is preferable to use CO₂. The effects on viscosity are smaller with N₂. Nitrogen is therefore mainly used to adjust to the desired cell structure.

The chamber comprising liquid for pelletization of the expandable thermoplastic polymer beads is preferably operated at a temperature in the range from 20 to 80° C., particularly preferably in the range from 30 to 60° C.

Examples of thermoplastic polymer that can be used are styrene polymers, polyamide (PA), polyolefins, such as polypropylene (PP) or polyethylene (PE), polyacrylates, such as polymethyl methacrylate (PMMA), polycarbonate (PC), polyesters, such as polyethylene terephthalate (PET) or polybutylene terephthalate (PBT), polyether sulfone (PES), polyether ketones (PEK), or polyether sulfides (PES), or a mixture thereof.

Preference is given to styrene copolymers, such as styrene-butadiene block copolymers, styrene-α-methylstyrene copolymer, acrylonitrile-butadiene-styrene (ABS), styrene-acrylonitrile (SAN), acrylonitrile-styrene-acrylate (ASA), methyl methacrylate-butadiene-styrene (MBS), methyl methacrylate-acrylonitrile-butadiene-styrene (MABS) polymers, impact-modified polystyrene (HIPS) or glassclear polystyrene (GPPS) that has been polymerized by a free-radical route, or anionically polymerized polystyrene (APS) or anionically polymerized impact-resistant polystyrene (AIPS).

The constitution of the polymer pellets can be selected appropriately for the desired properties of the molded foam. Styrene-butadiene block copolymers as styrene copolymer component have particular suitability for improving the elasticity and the resilience of the molded foam. Oil resistance, and also solvent resistance, in particular with respect to aromatic solvents, and heat resistance, can be improved by using acrylonitrile-containing styrene copolymers, such as SAN and ABS.

It is particularly preferable to use, in the process of the invention, a polymer melt comprising blowing agent and comprising
A) from 45 to 97.79 percent by weight of a styrene polymer,
B1) from 1 to 45 percent by weight of a polyolefin with a melting point in the range from 105 to 140° C.,
B2) from 0 to 25 percent by weight of a polyolefin with a melting point below 105° C.,
C1) from 0.1 to 25 percent by weight of a styrene-butadiene block copolymer or styrene-isoprene block copolymer,
C2) from 0 to 10 percent by weight of a styrene-ethylene-butylene block copolymer,
D) from 0.1 to 5% by weight of a nucelating agent,
E) from 1 to 10% by weight of a blowing agent which in essence remains within the polymer beads, and
F) from 0.01 to 5% by weight of a co-blowing agent forming the cavities, based in each case on the polymer melt comprising blowing agent.

Component A

The polymer beads comprise from 45 to 97.8% by weight, particularly preferably from 55 to 78.1% by weight, of a styrene polymer A), such as standard polystyrene (GPPS) or impact-resistant polystyrene (HIPS), or styrene-acrylonitrile copolymers (SAN), or acrylonitrile-butadiene-styrene copolymers (ABS), or a mixture thereof. The expandable, thermoplastic polymer beads used to produce the foam beads P1 preferably comprise, as styrene polymer A), standard polystyrene (GPPS). Particular preference is given to standard polystyrene grades with weight-average molar masses in the range from 120 000 to 300 000 g/mol, in particular from 190 000 to 280 000 g/mol, determined by gel permeation chromatography; and with a melt volume rate MVR (200° C./5 kg) to ISO 113 in the range from 1 to 10 cm³/10 min, an example being PS 158 K, 168 N, or 148 G from BASF SE. Free-flowing grades, such as Empera® 156L (Innovene) can be added in order to improve fusion of the foam beads during processing to give the molding.

Components B

The thermoplastic polymer beads comprise, as components B), polyolefins B1) with a melting point in the range from 105 to 140° C., and polyolefins B2) with a melting point below 105° C. The melting point is the melting peak determined by means of DSC (dynamic scanning calorimetry) at a heating rate of 10° C./minute.

The thermoplastic polymer beads comprise from 1 to 45 percent by weight, preferably from 4 to 35% by weight, particularly preferably from 7 to 15% by weight, of a polyolefin B1). The polyolefin B1) used preferably comprises a homo- or copolymer of ethylene and/or propylene with a density in the range from 0.91 to 0.98 g/l (determined to ASTM D792), in particular polyethylene. Particular polypropylenes that can be used are injection-molding grades. Polyethylenes that can be used are commercially available homopolymers made of ethylene, e.g. LDPE (injection-molding grades), LLDPE, HDPE, or copolymers made of ethylene and propylene (e.g. Moplen® RP220 and Moplen® RP320 from Basell, or Versify® grades from Dow), ethylene and vinyl acetate (EVA), ethylene acrylates (EA) or ethylene-butylene acrylates (EBA). The melt volume index MVI (190° C./2.16 kg) of the polyethylenes is usually in the range from 0.5 to 40 g/10 min, the density being in the range from 0.91 to 0.95 g/cm³. It is also possible to use blends with polyisobutene (PIB) (e.g. Oppanol® B150 from BASF Aktengesellschaft). It is particularly preferable to use LLDPE with a melting point in the range from 110 to 125° C. and with a density in the range from 0.92 to 0.94 g/l.

Other suitable components B1) are olefin block copolymers, where these are composed of a polyolefin block PB1 (hard block) and of a polyolefin block PB2 (soft block), for example those described in WO 2006/099631. The polyolefin block PB1 is preferably composed of from 95 to 100% by weight of ethylene. The PB2 block is preferably composed of ethylene and α-olefin, where the following can be used as α-olefins: styrene, propylene, 1-butene, 1-hexene, 1-octene, 4-methyl-1-pentene, norbornenes, 1-decene, 1,5-hexadiene, or a mixture thereof. It is preferable to use, as PB2 block, an ethylene-α-olefin copolymer block having from 5 to 60% by weight of α-olefin, in particular an ethylene-octene copolymer block. Preference is given to multiblock copolymers of the formula (PB1-PB2)n, where n represents an integer from 1 to 100. The blocks PB1 and PB2 in essence form a linear chain and preferably have alternating or random distribution. The proportion of the PB2 blocks is preferably from 40 to 60% by weight, based on the olefin block copolymer. Preference is particularly given to olefin block copolymers having alternating hard PB1 blocks and soft, elastomeric PB2 blocks, these being obtainable commercially with trademark INFUSE®.

Blowing-agent-retention capability increases markedly with a relatively small proportion of polyolefin B1). This markedly improves the storage stability and the processability of the expandable, thermoplastic polymer beads. In a range from 4 to 20% by weight of polyolefin, expandable thermoplastic polymer beads are obtained with good storage capability, without any impairment of the elastic properties of the molded foam produced therefrom. This is apparent by way of example in a relatively low compression set εₛₑₜ in a range from 25 to 35%.

The expandable, thermoplastic polymer beads comprise, as polyolefin B2), from 0 to 25 percent by weight, preferably from 1 to 15% by weight, particularly preferably from 5 to 10 percent by weight, of a polyolefin B2) with a melting point below 105° C. The polyolefin B2) preferably has a density in the range from 0.86 to 0.90 g/l (determined to ASTM D792). Thermoplastic elastomers based on olefins (TPOs) are particularly suitable for this purpose. Particular preference is given to ethylene-octene copolymers, which by way of example are obtainable commercially with trademark Engage® 8411 from Dow. After processing to give foam moldings, expandable, thermoplastic polymer beads which comprise component B2) exhibit a marked improvement in bending energy and ultimate tensile strength.

Components C

In the field of multiphase polymer systems, it is known that most polymers have no, or only slight, mutual miscibility (Flory), and demixing to give respective phases therefore occurs as a function of temperature, pressure, and chemical constitution. If incompatible polymers are linked covalently to one another, the demixing does not occur at a macroscopic level, but only at a microscopic level, e.g. on the scale of the length of a single polymer chain. The term microphase separation is therefore used in this case. There is a wide variety of resultant mesoscopic structures, e.g. lamellar, hexagonal, cubic, and bicontinuous morphologies, where these have a strong relationship to lyotropic phases.

Compatibilizers (components C) are used for controlled adjustment to the desired morphology. The invention achieves improved compatibility via use, as component C1), of a mixture of styrene-butadiene block copolymers or styrene-isoprene block copolymers, and of styrene-ethylene-butylene block copolymers (SEBS) as component C2).

The compatibilizers lead to improved adhesion between polyolefin-rich and styrene-polymer-rich phases, and even small amounts improve the elasticity of the foam markedly in comparison with conventional EPS foams. Studies of the domain size of the polyolefin-rich phase have shown that the compatibilizer stabilizes small droplets by reducing surface tension.

The expandable, thermoplastic polymer beads are particularly preferably composed of a multiphase polymer mixture which comprises blowing agent and which has at least one continuous phase, and which has at least two disperse phases P1 and P2 dispersed within the continuous phase, where
a) the continuous phase consists essentially of component A,
b) the first disperse phase P1 consists essentially of components B1 and B2, and
c) the second disperse phase P2 consists essentially of component C1.

Components C2) preferably form a phase boundary between the disperse phase P1 and the continuous phase.

By virtue of said additional disperse phase it is possible to keep the domain size of the disperse phase <2 μm, with relatively high soft-phase content. This leads to relatively high bending energy in the molded foam, for identical expandability.

The entirety of components C1) and C2) in the expandable, thermoplastic polymer beads is preferably in the range from 3.5 to 30 percent by weight, particularly preferably in the range from 6.8 to 18 percent by weight.

The ratio by weight of the entirety of components B1) and B2) to component C2) in the expandable, thermoplastic polymer beads is preferably in the range from 5 to 70.

The ratio by weight of components C1) to C2) in the expandable, thermoplastic polymer beads is preferably in the range from 2 to 5.

The expandable, thermoplastic polymer beads comprise, as component C1), from 0.1 to 25 percent by weight, preferably from 1 to 15 percent by weight, in particular from 6 to 9.9 percent by weight, of a styrene-butadiene block copolymer or styrene-isoprene block copolymer.

Suitable materials for this purpose by way of example are styrene-butadiene block copolymers or styrene-isoprene block copolymers. Total diene content is preferably in the range from 20 to 60% by weight, particularly preferably in the range from 30 to 50% by weight, and total styrene content is accordingly preferably in the range from 40 to 80% by weight, particularly preferably in the range from 50 to 70% by weight.

It is preferable to use, as compatibilizer, styrene-butadiene-styrene (SBS) three-block copolymers having butadiene content of from 20 to 60% by weight, preferably from 30 to 50% by weight, where these can have been to some extent hydrogenated or not hydrogenated. They are obtainable commercially by way of example with trademark Styroflex® 2G66, Styrolux® 3G55, Styroclear® GH62, Kraton® D 1101, Kraton® D 1155, Tuftec® H1043, or Europren® SOL T6414. These involve SBS block copolymers with sharp transitions between B blocks and S blocks.

The expandable, thermoplastic polymer beads comprise, as component C2), from 0.1 to 10 percent by weight, preferably from 1 to 9.9% by weight, in particular from 0.8 to 5 percent by weight, of a styrene-ethylene-butylene block copolymer (SEBS). Suitable styrene-ethylene-butylene block copolymers (SEBS) are by way of example those obtainable via hydrogenation of the olefinic double bonds of the block copolymers C1). Suitable styrene-ethylene-butylene block copolymers are by way of example the Kraton® G grades obtainable commercially, in particular Kraton® G 1650.

The process of the invention can give expandable thermoplastic polymer bead material with cavities with an average diameter in the range from 0.1 to 50 μm, preferably from 1 to 30 μm.

It is preferable for the expandable thermoplastic polymer bead material to have an average diameter in the range from 0.2 to 2.5 mm and to have from 50 to 300 cavities/mm² of cross-sectional area, preferably from 70 to 150 cavities/mm². The number of cavities can by way of example be determined via counting from a thin layer through the polymer bead material under an optical microscope.

The bulk density of the material is preferably in the range from 500 to 590 kg/m³, preferably from 520 to 580 kg/m³.

The prenucleated structure of the expandable pellets can give better foamability and controlled adjustment of cell size, and therefore a significant improvement in processing properties and in foam properties.

In order to improve processability, the finished expandable thermoplastic polymer beads can be coated with glycerol esters, antistatic agents, or anticaking agents.

The resultant round or oval beads are preferably foamed to a diameter in the range from 0.2 to 10 mm. Their bulk density is preferably in the range from 10 to 100 g/l.

The fusion of the prefoamed foam beads to give the molding, and the resultant mechanical properties, are in particular improved via coating of the expandable thermoplastic polymer beads with a glycerol stearate. It is particularly preferable to use a coating made of from 50 to 100% by weight of glycerol tristearate (GTS), from 0 to 50% by weight of glycerol monostearate (GMS), and from 0 to 20% by weight of silica.

The expandable, thermoplastic polymer beads can be prefoamed by means of hot air or steam to give foam beads with a density in the range from 8 to 200 kg/m³, preferably in the range from 10 to 80 kg/m³, in particular in the range from 10 to 50 kg/m³, and then fused in a closed mold to give foam moldings. A gauge pressure in the range from 0.5 to 1.5 bar, in particular from 0.7 to 1.0 bar, is usually used.

Use of this concept can markedly reduce blowing agent contents in comparison with standard EPS for achieving comparable densities, and can thus use less of the blowing agents that cause a greenhouse effect. Lower minimum bulk densities can thus be achieved with identical blowing agent content. Furthermore, it is substantially easier to reimpregnate prenucleated pellets with blowing agents, for example in the event of blowing agent loss during storage or transport. Since the prenucleation process can use nitrogen or other inert gases which have previously been obtained from the atmosphere, this concept for improving the expansion capability of thermoplastic moldable foams and for better adjustment of cell structure protects the environment and conserves resources.

The co-blowing agents F) used, forming cavities, generally have marked plastifying effect if their amounts are relatively large. The viscosity-lowering effect of the co-blowing agent F) therefore permits an increase in throughput at identical temperature profile or reduced melt temperature for identical throughput, for a formulation which is otherwise identical. The pressure drop in pressurized apparatuses, such as pelletizing dies or mixers, remains identical here, since the material has identical melt viscosity. In the first instance, therefore, the thermal stress placed on the material can be reduced, and it is also possible to incorporate heat-sensitive materials, such as flame retardants. In the second instance, the increase in throughput obtained with identical plant equipment/pressurization of the apparatuses permits more cost-effective production of the expandable beads.

Another aspect is that the proportion of the actual blowing agent can be reduced without changing melt viscosity, and without any need to adjust the throughput of the plant or the conduct of the process. Preference is given to carbon dioxide as plastifying co-blowing agent F), because of relatively high solubility in polymers.

The expandable thermoplastic polymer beads obtained by the process of the invention can be processed to give foams with relatively high cell number, i.e. fine cell structure. The homogeneous foam structure improves the mechanical properties and thermal insulation properties of the foams.

A further effect is reduction of energy costs for foam processing. The faster prefoaming process can achieve higher throughputs. The lower blowing agent contents in conjunction with the prenucleation process can markedly reduce demolding times, and can shorten cycle times for the complete foaming process.

### EXAMPLES

Starting Materials:

Component A:

Polystyrene with a melt viscosity index MVI (200° C./5 kg) of 2.9 cm³/10 min (PS 158K from BASF SE, M_{w}=280 000 g/mol, intrinsic viscosity number IV 98 ml/g)

Component B:
B1: LLDPE polyethylene (LL1201 XV, Exxon Mobile, density 0.925 g/l, MVI=0.7 g/10 min, melting point 123° C.)
B2: Ethylene-octene copolymer polyethylene (Engage® 8402 from Dow, density 0.880 g/l, MVI=18 g/10 min, melting point 72° C.)

Component C:
C1.1: Styrolux® 3G55, styrene-butadiene block copolymer from BASF SE,
C1.2: Styroflex® 2G66, thermoplastic elastic styrene-butadiene block copolymer (STPE) from BASF SE,
C2: Kraton G 1651, styrene-ethylene-butylene block copolymer from Kraton Polymers LLC

Component D:
D Nucleating agent: talc

Component E:
E Blowing agent mixture made of 95% by weight of isopentane and 5% by weight of n-pentane

Component F:
F Nitrogen co-blowing agent (Examples E1-E17), carbon dioxide co-blowing agent (Examples E19-E36)

Production of Expandable Pellets E1-E11

The expandable pellets were produced by a melt impregnation process using static mixing apparatuses. For this, the polymers were first plastified in an extruder and conveyed by way of a melt pump into a series of static mixers and heat exchangers. At the inlet of the first static mixer, technical-grade isopentane (95% isopentane/5% n-pentane) was added together with co-blowing agent F), and the melt was impregnated. The corresponding formulations can be found in Table 1. The melt temperature was then reduced by way of a heat exchanger, and the melt temperature was homogenized by way of a further static mixer. Pressure was applied via a further melt pump, in order to pelletize the material by way of a pelletizing die (49 0.60 mm holes) using pressurized underwater pelletization (water pressure 12 bar, water temperature 50° C.). Average bead size was about 1.25 mm. Total throughput was 70 kg/h. Melt temperature on discharge from the die was about 203° C.

TABLE 1
Constitution (parts by weight) of expandable pellets E1-E11

| | E1 | E2 | E3 | E4 | E5 | E6 | E7 | E8 | E9 | E10 | E11 |
|---|---|---|---|---|---|---|---|---|---|---|---|
| Component A | 70.2 | 70.25 | 70.2 | 70.15 | 70.1 | 70.05 | 70 | 70.1 | 70.1 | 71.3 | 71.2 |
| Component B1 | 11.7 | 11.7 | 11.7 | 11.7 | 11.7 | 11.7 | 11.7 | 11.7 | 11.7 | 11.7 | 11.7 |
| Component B2 | 3.9 | 3.9 | 3.9 | 3.9 | 3.9 | 3.9 | 3.9 | 3.9 | 3.9 | 3.9 | 3.9 |
| Component C1.1 | | | | | | | | 7.8 | 7.8 | 7.8 | 7.8 |
| Component C1.2 | 7.8 | 7.8 | 7.8 | 7.8 | 7.8 | 7.8 | 7.8 | | | | |
| Component C2 | | | | | | | | | 1.0 | 1.0 | 1.0 |
| Component D | 0.5 | 0.5 | 0.5 | 0.5 | 0.5 | 0.5 | 0.5 | 0.5 | 0.5 | 0.5 | 0.5 |
| (talc) | | | | | | | | | | | |
| Component E | 5.9 | 5.8 | 5.8 | 5.8 | 5.8 | 5.8 | 5.8 | 5.8 | 5.8 | 4.8 | 4.8 |
| (blowing agent) | | | | | | | | | | | |
| Component F | | 0.05 | 0.10 | 0.15 | 0.20 | 0.25 | 0.30 | 0.20 | 0.20 | 0.05 | 0.10 |
| (nitrogen) | | | | | | | | | | | |

Analysis of Expandable Pellets

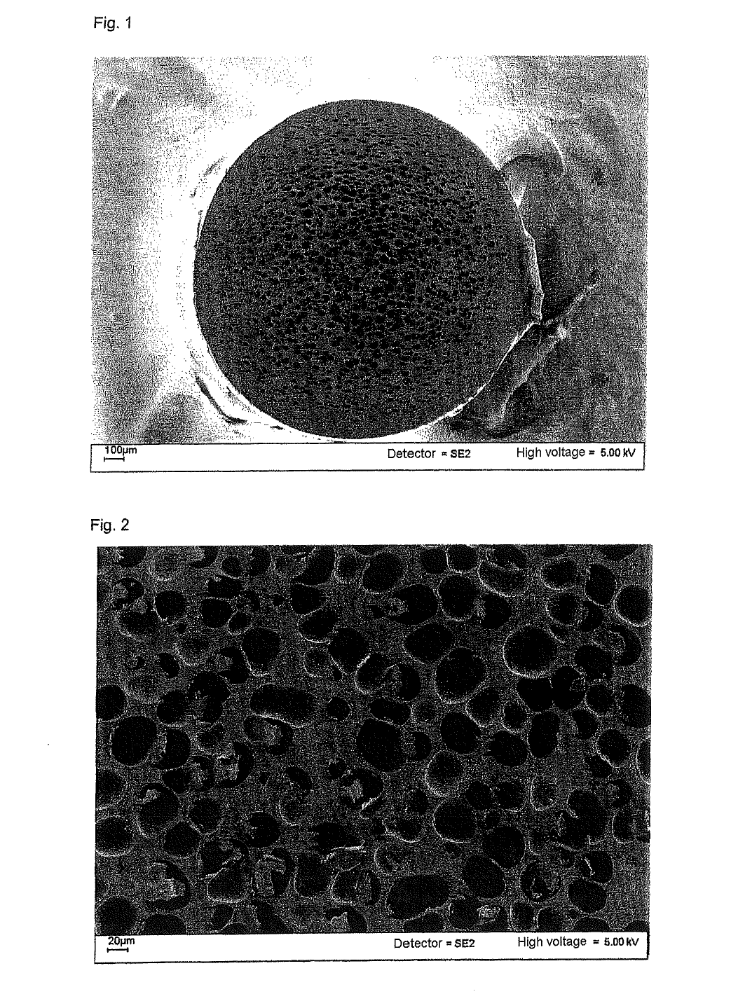

The transmission electron micrographs (TEMs) show the cellular structures of the pellets comprising blowing agent in the form of spheroidal cells (dark regions, FIG. 1), and these subsequently contribute to better expansion capability and finer cell structure in the foam. The order of size of the cells of these pellets that have absorbed blowing agent is below 50 μm, and cell sizes extending to 1 μm are clearly discernible in the recorded images.

Processing and Characterization of Expandable Pellets

Coating components used were 70% by weight of glycerol tristearate (GTS) and 30% by weight of glycerol monostearate (GMS).

The pellets comprising blowing agent were prefoamed in an EPS prefoamer to give foam beads of low density (from 15 to 25 g/l), and were processed in an automatic EPS molding machine at a gauge pressure of from 0.7-1.1 bar to give moldings.

The moldings were subjected to various mechanical measurements. Marked elastification is observed in the examples of the invention in comparison with straight EPS, and is discernible in very high resilience. Compressive strength was determined at 10% compression to DIN EN 826 and flexural strength was determined to DIN EN 12089. Bending energy was determined from the values measured for flexural strength.

Table 2 shows the processing parameters, such as prefoaming time and demolding time. It can be clearly seen that the addition of nitrogen reduces prefoaming time and demolding time. It was also possible to achieve a marked reduction in cell size. Blowing agent content could moreover be markedly reduced in comparison with the reference, without impairment of properties.

TABLE 2
Processing and properties of the foam beads obtained from Examples E1-E15

| | E1 | E2 | E3 | E4 | E5 | E6 | E7 | E8 | E9 | E10 | E11 |
|---|---|---|---|---|---|---|---|---|---|---|---|
| Bulk density of | 615 | 605 | 600 | 560 | 550 | 530 | 520 | 530 | 530 | 560 | 540 |
| beads | | | | | | | | | | | |
| [g/l] | | | | | | | | | | | |
| Bead size d′ | 1.26 | 1.27 | 1.26 | 1.28 | 1.26 | 1.27 | 1.28 | 1.29 | 1.27 | 1.26 | 1.27 |
| [mm] | | | | | | | | | | | |
| Prefoaming time at | 218 | 178 | 154 | 119 | 108 | 89 | 90 | 92 | 85 | 193 | 157 |
| 0.1 bar [s] | | | | | | | | | | | |
| Bulk density of foam | 21.3 | 20.8 | 20.6 | 21.3 | 20.5 | 20.8 | 20.5 | 20.4 | 20.8 | 20.5 | 20.9 |
| bead [g/l] | | | | | | | | | | | |
| Time for minimum | 660 | 650 | 630 | 540 | 360 | 300 | 240 | 290 | 250 | 360 | 420 |
| bulk density [s] | | | | | | | | | | | |
| Minimum bulk | 20.0 | 19.2 | 17.9 | 17.5 | 17.2 | 17.2 | 16.7 | 17.2 | 17.2 | 19.2 | 17.9 |
| density [g/l] | | | | | | | | | | | |
| Density of molding | 22.2 | 20.9 | 20.5 | 22.0 | 20.4 | 21.3 | 21.0 | 22.1 | 21.2 | 21.4 | 21.1 |
| [g/l] | | | | | | | | | | | |
| Demolding time [s] | 454 | 426 | 402 | 370 | 344 | 297 | 236 | 289 | 273 | 219 | 195 |
| Cell number | 1.5 | 1.7 | 2.1 | 4.8 | 5.6 | 6.0 | 7.2 | 6.1 | 6.0 | 4.5 | 5.0 |
| [1/mm] | | | | | | | | | | | |
| Flexural strength | 295 | 291 | 270 | 268 | 265 | 252 | 261 | 283 | 292 | 279 | 268 |
| [kPa] | | | | | | | | | | | |
| Bending energy | 5.3 | 5.1 | 4.8 | 4.5 | 4.8 | 4 | 4.2 | 4.5 | 4.9 | 5.3 | 5.1 |
| [Nm] | | | | | | | | | | | |
| Compressive | 103 | 99 | 9 | 96 | 92 | 93 | 90 | 100 | 98 | 92 | 91 |
| strength s = 10% | | | | | | | | | | | |
| [kPa] | | | | | | | | | | | |
| Compression set | 23 | 23 | 23 | 31 | 31 | 30 | 39 | 28 | 25 | 32 | 34 |
| [%] | | | | | | | | | | | |

Production of Expandable Pellets E 12-E17

The expandable pellets were produced by a melt impregnation process. For this, polystyrene 158 K (component A) was first plastified in an extruder. Within the extruder, the melt was impregnated with technical-grade isopentane (95% isopentane/5 n-pentane) together with the co-blowing agent F), and was homogenized. The corresponding formulations can be found in Table 3. Pressure was applied via a melt pump at the extruder head, in order to pelletize the material by way of a pelletizing die (2 0.65 mm holes) using pressurized underwater pelletization (water pressure 12 bar, water temperature 47° C.). Average bead size was about 1.25 mm. Total throughput was 4.5 kg/h. Melt temperature on discharge from the die was about 210° C.

TABLE 3
Constitution of expandable pellets, processing and properties of foam beads obtained from
Examples E12-E17

| | | E12 | E13 | E14 | E15 | E16 | E17 |
|---|---|---|---|---|---|---|---|
| Component A (GPPS) | | 93.4 | 93.3 | 93.1 | 93.9 | 93.8 | 93.6 |
| Component D (talc) | | 0.5 | 0.5 | 0.5 | — | — | — |
| Component E (blowing agent) | | 6.1 | 6.1 | 6.1 | 6.1 | — | — |
| Component F (nitrogen) | | — | 0.10 | 0.30 | 0.15 | 0.10 | 0.30 |
| Bulk density of beads | g/l | 550 | 470 | 360 | 620 | 610 | 420 |
| Bead size d′ | mm | 1.57 | 1.58 | 1.59 | 1.59 | 1.60 | 1.58 |
| Prefoaming time at 0.1 bar | s | 63 | 40 | 31 | 256 | 240 | 38 |
| Bulk density of foam beads | g/l | 20.5 | 21.3 | 21.2 | 20.6 | 20.2 | 21.3 |
| Time for minimum bulk density | s | 420 | 240 | 120 | 540 | 360 | 150 |
| Minimum bulk density | g/l | 13.5 | 12.2 | 13.5 | 20.0 | 17.9 | 12.8 |
| Density of molding | g/l | 21.4 | 22.7 | 21.6 | 20.3 | 15.2 | 22.6 |
| Demolding time | s | 56 | 114 | 52 | 36 | 87 | 469 |
| Cell number | 1/mm | 6.1 | 9.3 | 16.8 | 0.6 | 1.2 | 7.4 |
| Flexural strength | kPa | 314 | 342 | 263 | 118 | 99 | 317 |
| Bending energy | Nm | 3.3 | 4.2 | 3.3 | 1.8 | 1.4 | 3.5 |
| Compressive strength [symbol] = 10% | kPa | 139 | 138 | 116 | 41 | 33 | 140 |
| Compression set | % | 34 | 31 | 52 | 57 | 48 | 36 |

FIG. 1 and FIG. 2 show transmission electron micrographs at various magnifications of a thin section through an expandable pellet from Example 13 with homogeneously distributed cavities in the interior of the pellet bead.

Production of Expandable Pellets

The expanable pellets were produced by a melt impregnation process using static mixing apparatuses. For this, the polymers were first plastified in an extruder and metered by way of a melt pump into a series of static mixers and heat exchangers. At the inlet of the first static mixer, technical-grade isopentane (95% isopentane/5% n-pentane) was added together with the co-blowing agent F), and the melt was impregnated. The corresponding formulations can be found in the table. The melt temperature was then reduced by way of a heat exchanger, and the melt temperature was homogenized by way of a further static mixer. Pressure was applied via a further melt pump in order to pelletize the material by way of a pelletizing die (2 0.65 mm holes) using pressurized underwater pelletization (for water pressure see table, water temperature 47° C.). Average bead size was about 1.25 mm. Total throughput was 4.5 kg/h. Melt temperature on discharge from the die was about 207° C.

Production of Expandable Pellets, Examples 19 to 36

The expandable pellets were produced by a melt impregnation process using static mixing apparatuses. Table 4 gives an overview of the constitution of the materials—the quantitative proportions of the polymers and, respectively, of the talc (components A-D) were identical with those of Examples 12 and 1, and the proportion of the blowing agent E) and of the co-blowing agent F) was varied. For this, the polymers were first plastified in an extruder, and metered by way of a melt pump into a series of static mixers and heat exchangers. At the inlet of the first static mixer, technical-grade isopentane (95% isopentane/5% n-pentane) was added together with the co-blowing agent F), and the melt was impregnated. The procedure was analogous to that of Example 12 and Example 9, but instead of nitrogen CO₂ was used as component F) to reduce thermal stress. The corresponding formulations can be found in the table. The melt temperature was then reduced by way of a heat exchanger, and the melt temperature was homogenized by way of a further static mixer. Pressure was applied via a further melt pump in order to pelletize the material by way of a pelletizing die (2 0.65 mm holes) using pressurized underwater pelletization (for water pressure see table, water temperature 47° C.). Average bead size was about 1.25 mm. Total throughput was 4.5 kg/h.

In order to demonstrate the plastifying action and the throughput increases and, respectively, reduced melt temperatures that can be achieved, pressure loss across a static mixer was in each case used as a measure of melt viscosity. The diameter of the static mixer used was 25 mm and its L/D ratio was 15. The relationship between the pressure loss here and the viscosity in the laminar region is as follows:

$$Δ p = Re Ne \overline{η} \overline{w} \frac{L}{{D}^{2}}$$

where Re, Ne, η̅, w̅, L, and D are the Reynolds number, the Ne number, the average shear viscosity, the average flow rate, the length of the static mixer, and the diameter of the static mixer. For CSE-X/8 static mixers, the product of Ne and Re is constant and is 1200. The average flow rate is:

$$\overline{w} = \frac{\dot{V}}{A} = \frac{( \dot{m} / ρ )}{π ( {D}^{2} / 4 )}$$

where \dot{V}, \dot{m}, ρ and A are the volumetric throughput, the mass-based throughput, the melt density, and the cross-sectional area of the mixer. The average shear viscosity of the polymer melt, η̅ at the average shear rate {dot over ( γ̅ is calculated as follows:

$$\overline{η} ( \overline{\dot{γ}} ) = \overline{η} ( \frac{64}{D} \cdot \frac{( \dot{m} / ρ )}{π ( {D}^{2} / 4 )} )$$

On the basis of these principles, the shear viscosity of the melt was determined (Table 4) at various temperatures and throughputs. Examples 19 to 36 in each case give the effect of CO₂ on viscosity and on pressure loss (at the static mixer/additive mixer). Pressure loss here is a variable involving technical restrictions, since there is a maximum permissible pressure loss at the mixer and a permissible total system pressure. By using CO₂, it is possible to reduce the thermal stress (24/25, 33/34) or to increase the throughput (26/27, 35/36) for identical pressure loss in comparison with the system comprising only pentane. The use of CO₂ here has no adverse effect on foaming performance.

| | Components | | | | | | |
|---|---|---|---|---|---|---|---|
| | without | Total | | | Pressure | Average | |
| | blowing | throughput | Pentane | CO₂ | loss | viscosity | Temperature |
| Example | agent | (kg/h) | (% by wt.) | (% by wt.) | (bar) | (Pa · s) | (° C.) |
| E19 | B12 | 4.5 | 6.5% | 0.0% | 26 | 1.276 | 183 |
| E20 | B12 | 4.5 | 3.8% | 0.0% | 65 | 3.212 | 183 |
| E21 | B12 | 4.5 | 3.8% | 0.5% | 56 | 2.756 | 183 |
| E22 | B12 | 4.5 | 3.8% | 1.0% | 47 | 2.304 | 182 |
| E23 | B12 | 4.5 | 3.7% | 2.8% | 30 | 1.467 | 183 |
| E24 | B12 | 4.5 | 3.8% | 1.0% | 64 | 3.140 | 175 |
| E25 | B12 | 4.5 | 3.7% | 2.8% | 66 | 3.238 | 158 |
| E26 | B12 | 6.2 | 3.8% | 1.0% | 62 | 2.208 | 183 |
| E27 | B12 | 11.0 | 3.7% | 2.8% | 64 | 1.285 | 183 |
| E28 | B1 | 4.5 | 6.1% | 0.0% | 48 | 2.314 | 187 |
| E29 | B1 | 4.5 | 6.1% | 0.5% | 44 | 2.127 | 186 |
| E30 | B1 | 4.5 | 6.0% | 0.9% | 40 | 1.906 | 186 |
| E31 | B1 | 4.5 | 6.0% | 1.4% | 36 | 1.703 | 186 |
| E32 | B1 | 4.5 | 6.0% | 1.8% | 32 | 1.546 | 186 |
| E33 | B1 | 4.5 | 6.0% | 0.9% | 46 | 2.207 | 178 |
| E34 | B1 | 4.5 | 6.0% | 1.8% | 47 | 2.255 | 169 |
| E35 | B1 | 6.1 | 6.0% | 0.9% | 48 | 1.699 | 186 |
| E36 | B1 | 8.0 | 6.0% | 1.8% | 46 | 1.241 | 186 |

1-10. (canceled)

11. A process for producing expandable, thermoplastic polymer beads comprising cavities via extrusion of a polymer melt comprising blowing agent through a die plate and pelletization in a chamber comprising liquid under a pressure in the range from 1.5 to 15 bar, which comprises using a polymer melt comprising blowing agent, where the melt comprises
from 0.1 to 5% by weight of a nucleating agent D),
from 1 to 10% by weight of a blowing agent E) which in essence remains within the polymer beads,
from 0.01 to 5% by weight of a co-blowing agent F) forming the cavities, based in each case on the polymer melt comprising blowing agent.

12. The process according to claim 11, wherein the nucleating agent D) is talc, silicon dioxide, mica, clay, zeolites, calcium carbonate, or a polyethylene wax.

13. The process according to claim 11, wherein the blowing agent E) is an aliphatic C3-C7-hydrocarbon or a mixture thereof.

14. The process according to claim 11, wherein the as co-blowing agent F) is nitrogen, carbon dioxide, argon, helium, or a mixture thereof

15. The process according to claim 11, wherein the polymer melt comprising blowing agent comprises less than 0.5% by weight of water.

16. The process according to claim 11, wherein the chamber comprising liquid is operated at a temperature in the range from 20 to 80° C.

17. The process according to claim 11, wherein the polymer melt comprising blowing agent comprises
A) from 45 to 97.79 percent by weight of a styrene polymer,
B1) from 1 to 45 percent by weight of a polyolefin with a melting point in the range from 105 to 140° C.,
B2) from 0 to 25 percent by weight of a polyolefin with a melting point below 105° C.,
C1) from 0.1 to 25 percent by weight of a styrene-butadiene block copolymer or styrene-isoprene block copolymer,
C2) from 0 to 10 percent by weight of a styrene-ethylene-butylene block copolymer,
D) from 0.1 to 5% by weight of a nucelating agent,
E) from 1 to 10% by weight of a blowing agent which in essence remains within the polymer beads, and
F) from 0.01 to 5% by weight of a co-blowing agent forming the cavities, based in each case on the polymer melt comprising blowing agent.

18. The process according to claim 17, wherein the nucleating agent D) is talc, silicon dioxide, mica, clay, zeolites, calcium carbonate, or a polyethylene wax.

19. The process according to claim 18, wherein the blowing agent E) is an aliphatic C3-C7-hydrocarbon or a mixture thereof.

20. The process according to claim 19, wherein the as co-blowing agent F) is nitrogen, carbon dioxide, argon, helium, or a mixture thereof

21. The process according to claim 20, wherein the polymer melt comprising blowing agent comprises less than 0.5% by weight of water.

22. The process according to claim 21, wherein the chamber comprising liquid is operated at a temperature in the range from 20 to 80° C.

23. An expandable thermoplastic polymer bead material with cavities with an average diameter in the range from 0.1 to 50 μm, obtainable according to the process of claim 11.

24. The expandable thermoplastic polymer bead material according to claim 23, which has an average diameter in the range from 0.2 to 2.5 mm and has from 50 to 300 cavities/mm² of cross-sectional area.

25. The expandable thermoplastic polymer bead material according to claim 23, which has a bulk density in the range from 500 to 590 kg/m³.
